(19) United States
(12) Patent Application Publication
(10) Pub. No.: US 2026/0169211 A1
(43) Pub. Date: Jun. 18, 2026

(54) OPTICAL ELEMENT

(71) Applicant: CANON KABUSHIKI KAISHA, Tokyo (JP)

(72) Inventors: KAZUHIRO ARAI, Kanagawa (JP); KAZUHIRO KOGA, Kanagawa (JP); JUNJI KAWASAKI, Kanagawa (JP)

(21) Appl. No.: 19/419,834

(22) Filed: Dec. 15, 2025

(30) Foreign Application Priority Data
Dec. 17, 2024 (JP) 2024-220540

(51) Int. Cl. G02B 5/30

(52) U.S. Cl. CPC G02B 5/3066

(57) ABSTRACT

To prevent peeling of a metal film or an adhesion layer due to a thermal change in an optical element having a fine structure, provided is an optical element that includes a resin substrate having a base portion and a fine structure; and a metal film on a side surface of the fine structure. The convex structures are each formed at a corner portion formed by the side surface of the fine structure on which the metal film is formed, and a surface of the base portion, and an average value of volumes of the convex structures is 14,800 nm³ or more and 83,000 nm³ or less.

### BACKGROUND

### Field of the Technology

The present disclosure relates to an optical element having a fine structure.

### Description of the Related Art

Functions such as antireflection or polarization control can be imparted by forming a fine structure on a surface of an optical substrate. The average period of the fine structure to be formed is required to be shorter than the wavelength of a target wavelength band, in order to avoid a diffraction phenomenon in the target wavelength band. For example, when the visible light wavelength range is set as the target, the average period is required to be shorter than 400 nm, which is the shortest wavelength in the visible light range, and in general, a fine structure having an average period of 250 nm or less is used.

Methods of forming the fine structure may include a method using pattern formation with an electron beam drawing apparatus, a laser interference exposure apparatus, a semiconductor exposure apparatus, an etching apparatus, or the like, or a method using transfer formation with a mold having an inverted structure of the fine structure formed thereon.

Further, various optical functions can be achieved by forming a metal film on the fine structure obtained by the above-mentioned methods. Specifically, a reflective polarizing element can be formed by forming an aluminum film on a side surface of each of lines of a line-and-space structure by an oblique vapor deposition method or the like. The reflective polarizing element is an optical element used in a folded optical system that can be made thin and small, and application of such an optical element to head-mounted displays and small camera products is progressing.

In addition, in order to reduce manufacturing costs, a reflective polarizing element often uses a resin substrate having a line-and-space structure formed thereon by transfer. In this case, it is difficult to ensure sufficient adhesion force at an interface between the aluminum film and the line-and-space structure made of resin, and prevention of peeling by an adhesion layer has been proposed. See, Japanese Patent Laid-Open No. 2024-4491.

However, an inorganic material for forming the metal film or the adhesion layer, and a resin material for forming the line-and-space structure have greatly different thermal expansion coefficients, resulting in a problem in that peeling easily occurs due to, for example, a heat cycle.

### SUMMARY

The present disclosure is directed to prevent peeling of a metal film or an adhesion layer due to a thermal change in an optical element having a fine structure. An aspect of the present disclosure provides an optical element that includes a resin substrate having a base portion and a fine structure protruding from the base portion; a metal film formed on at least a part of a side surface of the fine structure; and a plurality of convex structures. Each convex structure of the plurality of convex structures is provided on a respective side surface on which the metal film is formed. An average value of volumes of the plurality of convex structures is 14,800 nm³ or more and 83,000 nm³ or less.

Another aspect of the present disclosure provides an optical element that includes a resin substrate having a base portion and a fine structure protruding from the base portion; an adhesion layer configured to cover a surface of the resin substrate; a metal film formed on at least a part of a side surface of the fine structure via the adhesion layer; and a plurality of convex structures. Each convex structure of the plurality of convex structures is provided on a surface of the base portion. An average value of volumes of the plurality of convex structures is 14,800 nm³ or more and 83,000 nm³ or less.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic plan view illustrating a configuration of the optical element according to an embodiment of the present disclosure.

FIG. 1B is a schematic sectional view illustrating the configuration of the optical element according to the embodiment of the present disclosure.

FIG. 2A, FIG. 2B, FIG. 2C, FIG. 2D, FIG. 2E, FIG. 2F, FIG. 2G, FIG. 2H, FIG. 2I, FIG. 2J, FIG. 2K and FIG. 2L are schematic sectional views illustrating a manufacturing process for the optical element illustrated in FIG. 1A and FIG. 1B.

FIG. 3A is a schematic plan view illustrating a configuration of another embodiment of the present disclosure.

FIG. 3B is a schematic sectional view illustrating the configuration of the another embodiment of the present disclosure.

FIG. 4A is a schematic plan view illustrating a configuration of still another embodiment of the present disclosure.

FIG. 4B is a schematic sectional view illustrating the configuration of the still another embodiment of the present disclosure.

FIG. 5A is a schematic plan view illustrating a configuration of a related-art optical element.

FIG. 5B is a schematic sectional view illustrating the configuration of the related-art optical element.

### DESCRIPTION OF THE EMBODIMENTS

An embodiment provides an optical element that includes a resin substrate having a base portion, and a fine structure protruding from the base portion; and a metal film formed on at least a part of a side surface of the fine structure, and the resin substrate has convex structures of a specific size, as further described below.

### First Embodiment

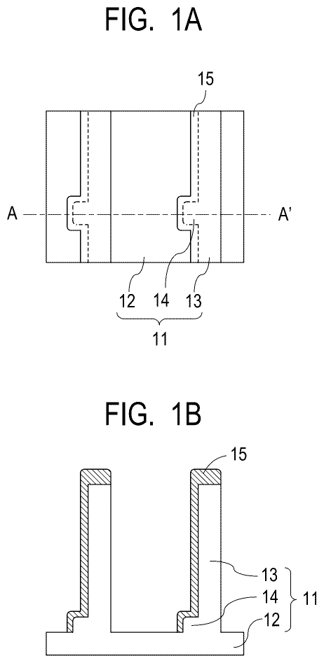

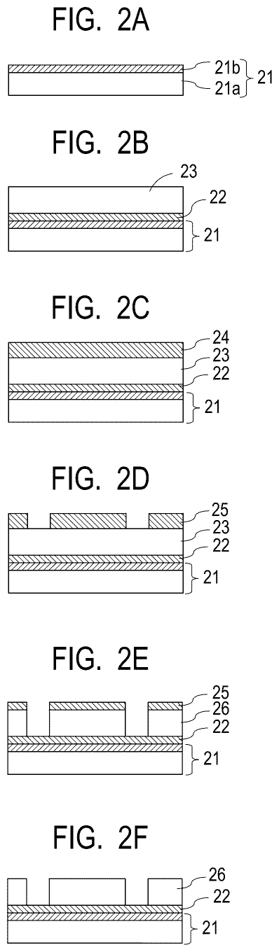

FIG. 1A and FIG. 1B show a configuration of an optical element according to a first embodiment of the present disclosure. FIG. 1A is a schematic plan view, and FIG. 1B is a schematic sectional view of a portion A-A′ in FIG. 1A. The broken line in FIG. 1A indicates a side surface of a fine structure 13 and a convex structure 14 of a resin substrate 11 in a case of the metal film 15 being removed.

The optical element of this embodiment includes the resin substrate 11 and the metal film 15. The resin substrate 11 has a base portion 12 and the fine structure 13 protruding from a surface of the base portion 12, and the fine structure 13 is a line-and-space structure in which linear protruding portions are arranged parallel to each other at a constant pitch. The convex structure 14 is formed only on one of a pair of side surfaces parallel to lines of the fine structure 13, and the metal film 15 is formed so as to cover the convex structure 14, the side surface having the convex structure 14, and further, a top surface of the fine structure 13.

In this embodiment, the convex structure 14 is a rectangular parallelepiped, and is formed at a corner portion formed by the side surface of the fine structure 13 and the surface of the base portion 12. With such a convex structure 14, an area of an interface between the metal film 15 and the resin substrate 11 is increased, thereby enhancing adhesion strength between the metal film 15 and the resin substrate 11, resulting in that peeling of the metal film 15 due to a thermal change being suppressed without impairing optical characteristics.

The resin substrate 11 and the metal film 15 have greatly different thermal expansion coefficients. The thermal expansion coefficient of a resin material may be on the order of 10×10⁻⁵/° C., and the thermal expansion coefficient of a metal material may be on the order of 10×10₋₆/° C. The thermal expansion coefficient of the resin material is about 10 times larger than the thermal expansion coefficient of the metal material. Further, while the dimension of the fine structure 13 is on the order of nm, the resin substrate 11 is an optical element and thus has a size on the order of at least mm. Accordingly, when the size of the resin substrate 11 changes due to a temperature change in the usage environment, stress concentrates at the corner portion formed by the side surface of the fine structure 13 and the base portion 12. In addition, the metal film 15 deforms only to about 1/10 of the resin substrate 11, and hence the metal film 15 cannot deform in the same amount as the resin substrate 11. As a result, the metal film 15 peels off, starting from around the corner portion formed by the side surface of the fine structure 13 and the base portion 12.

Accordingly, in an embodiment of the present disclosure, with the provision of the convex structure 14 at the corner portion formed by the side surface of the fine structure 13 and the base portion 12, the adhesion strength of a portion from which the peeling of the metal film 15 may be started can be locally increased, thereby preventing the peeling of the entire film.

Meanwhile, the provision of the convex structure 14 causes a deviation from original optical design values, resulting in that desired optical characteristics may not be obtained. Studies conducted for the present disclosure show a correlation between the dimension of the convex structure 14 and the change in optical characteristics, and clarify the dimensional range of the convex structure 14 that is usable as an optical element.

Specifically, when an average value of volumes of convex structures 14 is 14,800 nm³ or more and 83,000 nm³ or less, the peeling of the metal film 15 can be prevented without reducing optical characteristics.

In addition, in order to obtain the effect of preventing the peeling of the metal film 15 without reducing optical characteristics, conditions for the convex structure 14 are described below.

An area of an interface at which the resin substrate 11 is in contact with the metal film 15 is 160% or more and 680% or less of an area of the interface obtained in a case in which no convex structure 14 is provided.

An existence ratio of the convex structures 14 is 1% or more and 35% or less. The term existence ratio, as used herein, refers to a ratio of top surface areas of the convex structures 14 formed in a region in which the metal film 15 is formed within an evaluation area, with respect to the area of the evaluation area, in a plan view as seen from a normal direction of the surface of the base portion 12 on which the fine structure 13 is formed. That is, in FIG. 1A, the existence ratio refers to a ratio of the sum of top surface areas of a plurality of convex structures 14 covered with the metal film 15, with respect to the area of FIG. 1A. Here, in this embodiment, the existence ratio is evaluated using an image observed with an electron microscope at a magnification of 50,000, as the evaluation area. The size of the evaluation area is about 2.5 μm in width and about 2.0 μm in length.

A surface area of each convex structure of the plurality of convex structures 14 is 2,620 nm² or more and 9,230 nm² or less.

A height of the convex structure 14 (vertical direction on FIG. 1A) is 12 nm or more and 68 nm or less.

A shape and an area of the convex structure 14 in this embodiment can be obtained by selecting a predetermined region through observation with an electron microscope. Specifically, a size in a horizontal direction with respect to the base portion 12 is measured through observation from a top surface. A size in a vertical direction with respect to the base portion 12 corresponding to the height of the convex structure 14 is obtained by preparing a sample subjected to focused ion beam (FIB) cross-section processing, and measuring the height of the sample. However, it is difficult to evaluate the height of all the convex structures 14 existing in the evaluation area. Hence, in this embodiment, height measurement is performed on freely-selected five convex structures 14, and the average value obtained therefrom is used.

The resin substrate 11 may be any resin material having a transmittance of 90% or more at a wavelength of light to be used. In the visible light wavelength range, for example, polyester resin (PES), cycloolefin polymer resin (COP), polystyrene resin (PS), acrylic resin such as polymethyl methacrylate resin (PMMA), or polycarbonate resin (PC) can be used.

The fine structure 13 is a line-and-space structure in this embodiment, but may be any structure that achieves a desired optical function. For example, a hole structure, a pillar structure, or a moth-eye structure, and in the case of assuming a metamaterial, a ring-shaped structure, or a partially missing ring-shaped structure, may be used.

The metal film 15 may be any metal film that achieves desired optical characteristics. For example, in the visible light wavelength range, aluminum, silver, gold, copper, or the like can be used.

In the resin substrate 11, the base portion 12 and the fine structure 13 may be made of different resin materials or the same resin material, and may be formed as an integrally molded body made of the same resin material. Further, the convex structure 14 may also be made of a resin material different from or identical to the resin material for each of the base portion 12 and the fine structure 13, and may be molded integrally with the base portion 12 and the fine structure 13.

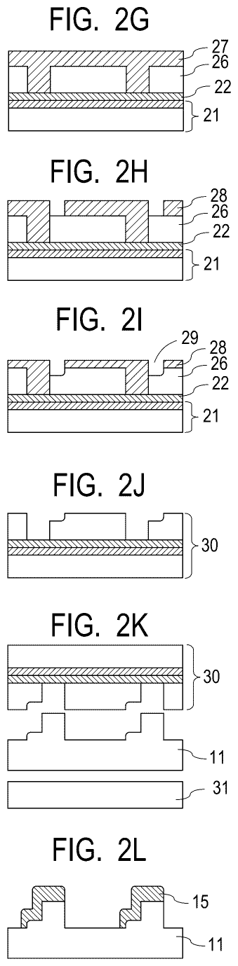

Now, a manufacturing method for the resin substrate 11 in which the base portion 12, the fine structure 13, and the convex structure 14 are formed as an integrally molded body is described. In this embodiment, an example of performing injection molding using a mold in which an inverted structure of the fine structure 13 has been formed is given. FIG. 2A to FIG. 2L are process diagrams of such a manufacturing method, providing schematic sectional views of the same portion as in FIG. 1B.

First, as illustrated in FIG. 2A, an injection mold 21 is prepared. The injection mold 21 includes a base portion 21a made of stainless steel; and a mirror surface portion 21b made of a nickel alloy.

Next, as illustrated in FIG. 2B, a titanium film 22 and a silicon dioxide film 23 are formed by a sputtering method.

Next, as illustrated in FIG. 2C, a photoresist layer 24 is formed by a spin coating method.

Next, as illustrated in FIG. 2D, a photoresist pattern 25 is obtained through exposure by an electron beam (EB) drawing method, followed by development.

Next, as illustrated in FIG. 2E, the silicon dioxide film 23 exposed in recesses of the photoresist pattern 25 is dry etched by a dry etching method using CHF₃ gas. Thus, a silicon dioxide pattern 26 is obtained.

Next, as illustrated in FIG. 2F, the resist pattern 25 is removed by an oxygen ashing method.

Next, as illustrated in FIG. 2G, a photoresist layer 27 is formed on the obtained silicon dioxide pattern 26, by a spin coating method.

Next, as illustrated in FIG. 2H, a photoresist pattern 28 is obtained through exposure of a region corresponding to the convex structure by the EB drawing method, followed by development.

Next, as illustrated in FIG. 2I, the silicon dioxide pattern 26 that is exposed in recesses of the photoresist pattern 28 is dry etched by a dry etching method using CHF₃ gas. Thus, recesses 29 are obtained in a top surface of the silicon dioxide pattern 26.

Next, as illustrated in FIG. 2J, the resist pattern 28 is removed by an oxygen ashing method. After that, a monomolecular mold release film is formed on surfaces of the silicon dioxide pattern 26 and the recesses 29, thereby obtaining a fine structure mold 30.

Next, as illustrated in FIG. 2K, the fine structure 13 and the convex structures 14 are transferred onto the surface of the resin substrate 11 simultaneously with the molding of the resin substrate 11, by performing injection molding using the fine structure mold 30 and a mold 31.

Next, as illustrated in FIG. 2L, a reflective polarizing element is obtained by forming the metal film 15 by oblique vapor deposition on the top surface and the side surface of the fine structure 13 and the surfaces of the convex structures 14.

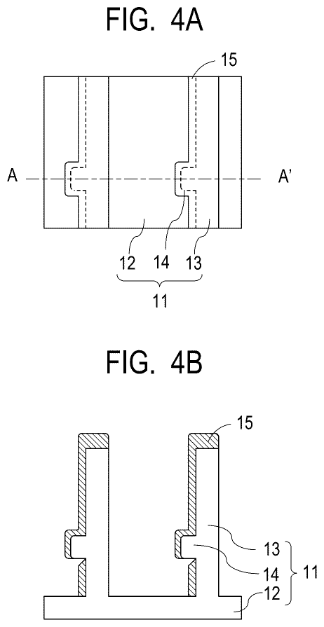

In this embodiment, the example has been given in which the convex structure 14 is formed at the corner portion formed by the side surface of the fine structure 13 and the surface of the base portion 12. However, the convex structure 14 need not always be formed at the corner portion as long as a contact area between the resin substrate 11 and the metal film 15 can be increased. For example, as illustrated in FIG. 4A and FIG. 4B, the convex structure 14 may be provided at a position away from the corner portion. However, in consideration of stress concentration due to thermal expansion, the convex structure 14 may be arranged at the corner portion. FIG. 4A is a schematic plan view, and FIG. 4B is a schematic sectional view of a portion A-A′ in FIG. 4A. The broken line in FIG. 4A indicates the side surface of the fine structure 13 and the convex structure 14 of the resin substrate 11 in a case of the metal film 15 being removed.

### Second Embodiment

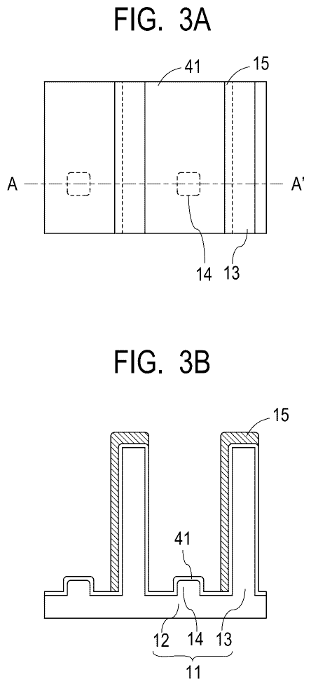

FIG. 3A and FIG. 3B show a configuration of an optical element according to a second embodiment of the present disclosure. FIG. 3A is a schematic plan view, and FIG. 3B is a schematic sectional view of a portion A-A′ in FIG. 3A. The broken line in FIG. 3A indicates the side surface of the fine structure 13 and the convex structure 14 of the resin substrate 11 in a case of the metal film 15 being removed.

The second embodiment is the same as the first embodiment except that the convex structure 14 is formed on the base portion 12 of the resin substrate 11 and an adhesion layer 41 is formed on the surface of the resin substrate 11. For conciseness, description of similar components as in the first embodiment is not repeated and rather is incorporated by reference.

Titanium, SiO, or chromium may be used for the adhesion layer 41. The convex structure 14 is formed on the base portion 12 between adjacent fine structures 13.

In this embodiment, the existence ratio of the convex structures 14 is a ratio of the sum of top surface areas of the convex structures 14 in the evaluation area with respect to the area of the evaluation area.

### EXAMPLES

### Example 1

An optical element was manufactured by the manufacturing method illustrated in FIG. 2A to FIG. 2L. Polyester resin (refractive index: 1.65) was used as the resin substrate 11. The fine structure 13 was set as a line-and-space structure having a pitch of 150 nm, a line width of 50 nm, and a line height of 200 nm.

The convex structures 14 were set to have a width in a line direction of 40 nm, a width in a pitch direction of 30 nm, and a height of 20 nm as an average value of a plurality of convex structures 14, and to have an existence ratio of 1%.

Aluminum was used as a material for the metal film 15, and a top surface film thickness of the fine structure 13 was set to 50 nm and a side surface film thickness thereof was set to 20 nm.

An injection mold 21 for forming the resin substrate 11 includes a base portion 21a made of stainless steel; and a mirror surface portion 21b made of a nickel alloy. A titanium film 22 and a silicon dioxide film 23 were formed on the mirror surface portion 21b by the sputtering method. A film thickness of the titanium film 22 was set to about 50 nm, and a film thickness of the silicon dioxide film 23 was set to about 250 nm.

Next, a photoresist layer 24 was formed by the spin coating method. Spin coating conditions were set to 3,000 rpm/20 seconds, and a film thickness of the photoresist layer 24 was about 150 nm. Next, a photoresist pattern 25 having a pitch of 150 nm, a line width of 50 nm, and a height of about 150 nm equivalent to the film thickness of the photoresist layer 24 was obtained through exposure by the EB drawing method, followed by development.

Next, the silicon dioxide film 23 exposed in recesses of the photoresist pattern 25 was dry etched by the dry etching method using CHF₃ gas. Thus, a silicon dioxide pattern 26 was obtained. In this Example, an etching time was adjusted so that a height of the silicon dioxide pattern 26 became about 200 nm.

Next, the resist pattern 25 was removed by the oxygen ashing method.

Next, a photoresist layer 27 was formed on the obtained silicon dioxide pattern 26 by the spin coating method. The spin coating conditions in this Example were set to 3,000 rpm/20 seconds, and a film thickness from the surface of the silicon dioxide pattern 26 to the surface of the photoresist layer 27 was about 50 nm.

Next, a photoresist pattern 28 was obtained through exposure of a region corresponding to the convex structures 14 by the EB drawing method, followed by development. In this Example, a pattern having a width in the line direction of 40 nm and a width in the pitch direction of 30 nm was formed. The height thereof was about 50 nm equivalent to the film thickness of the photoresist layer 27.

Next, the silicon dioxide pattern 26 exposed in recesses of the photoresist pattern 28 was dry etched by the dry etching method using CHF₃ gas. Thus, recesses 29 were obtained on the top surface of the silicon dioxide pattern 26. In this Example, an etching time was adjusted so that a depth of the recesses 29 became about 20 nm.

Next, the resist pattern 28 was removed by the oxygen ashing method. After that, a monomolecular mold release film was formed on the surfaces of the silicon dioxide pattern 26 and the recesses 29, thereby obtaining the fine structure mold 30.

Next, the fine structure 13 and the convex structures 14 were transferred onto the surface of the resin substrate 11 simultaneously with the molding of the resin substrate 11, by performing injection molding using the fine structure mold 30. When the shapes of the fine structure 13 and the convex structures 14 were evaluated using an electron microscope, it was found that the inverted structure of the fine structure mold 30 was substantially obtained.

Next, aluminum was deposited on the top surface and the side surface of the fine structure 13 and the surfaces of the convex structures 14 by oblique vapor deposition to form the metal film 15. Thus, a reflective polarizing element was obtained.

When the surfaces of the fine structure mold 30 and the resin substrate 11 were observed with an electron microscope, it was found that the silicon dioxide pattern 26 and the recesses 29 formed on the fine structure mold 30 were formed on the surface of the resin substrate 11.

When a heat cycle test was performed on the reflective polarizing element in this Example, no peeling of the metal film 15 was observed. The heat cycle conditions were set to a minimum temperature of −30° C. and a maximum temperature of 70° C., and 50 cycles were performed. Further, as a result of evaluating optical characteristics, P-polarized light transmittance was deteriorated by about 0.2% as compared to the case in which no convex structure 14 was formed (Comparative Example 1 described later), but fell within a range that did not affect product performance. The P-polarized light transmittance was evaluated by irradiating the reflective polarizing element with polarized light that vibrates perpendicularly to the line direction of the fine structure 13, and measuring the light amount of the transmitted light. The configuration and characteristics are shown in Table 1-1. The term Optical deterioration in Table 1-1 and Table 1-2 refers to a ratio of a decrease in the P-polarized light transmittance.

### Example 2

COP resin (refractive index: 1.53) was used as the resin substrate 11, and the fine structure 13 was set as a line-and-space structure having a pitch of 150 nm, a line width of 50 nm, and a line height of 250 nm. The convex structures 14 were set to have a width in the line direction of 30 nm, a width in the pitch direction of 30 nm, and a height of 68 nm, and the existence ratio of the convex structures 14 was set to 14%. Silver was used as a material for the metal film 15, and a top surface film thickness of the fine structure 13 was set to 60 nm and a side surface film thickness thereof was set to 20 nm. A reflective polarizing element was manufactured in the same manner as in Example 1 for other configurations and a manufacturing method.

When a heat cycle test was performed on the reflective polarizing element in this Example, no peeling of the metal film 15 was observed. Further, as a result of evaluating optical characteristics, P-polarized light transmittance was deteriorated by about 9.9% as compared to the case in which no convex structure 14 was formed. The decrease in transmittance was larger as compared to the case of Example 1, but the transmittance was able to fall within a range usable as product performance. Meanwhile, the larger increase in surface area was achieved by the convex structures 14, and hence it is expected that environmental durability is further improved. The configuration and characteristics are shown in Table 1-1.

### Example 3

PC resin (refractive index: 1.59) was used as the resin substrate 11, and the fine structure 13 was set as a line-and-space structure having a pitch of 120 nm, a line width of 40 nm, and a line height of 100 nm. The convex structures 14 were set to have a width in the line direction of 35 nm, a width in the pitch direction of 38 nm, and a height of 12 nm, and the existence ratio of the convex structures 14 was set to 30%. Aluminum was used for the metal film 15, and a top surface film thickness of the fine structure 13 was set to 50 nm and a side surface film thickness thereof was set to 40 nm. A reflective polarizing element was manufactured in the same manner as in Example 1 for other configurations and a manufacturing method.

When a heat cycle test was performed on the reflective polarizing element in this Example, no peeling of the metal film 15 was observed. Further, as a result of evaluating optical characteristics, P-polarized light transmittance was deteriorated by about 3.8% as compared to the case in which no convex structure 14 was formed, but was able to fall within a range usable as product performance. The configuration and characteristics are shown in Table 1-1.

### Example 4

As illustrated in FIG. 3A and FIG. 3B, an optical element having an adhesion layer 41 and the convex structures 14 formed on the surface of the base portion 12 was manufactured. PMMA resin (refractive index: 1.49) was used as the resin substrate 11, and the fine structure 13 was set as a line-and-space structure having a pitch of 250 nm, a line width of 70 nm, and a line height of 100 nm. The convex structures 14 were set to have a width in the line direction of 30 nm, a width in the pitch direction of 25 nm, and a height of 20 nm, and the existence ratio of the convex structures 14 was set to 5%.

Titanium was used for the adhesion layer 41, and the adhesion layer 41 was formed by normal vapor deposition to have a film thickness of about 20 nm so as to cover the base portion 12, the fine structure 13, and the convex structures 14. Aluminum was used for the metal film 15, and a top surface film thickness of the fine structure 13 was set to 50 nm and a side surface film thickness thereof was set to 30 nm. A reflective polarizing element was manufactured in the same manner as in Example 1 for other configurations and a manufacturing method.

When a heat cycle test was performed on the reflective polarizing element in this Example, no peeling of the adhesion layer 41 and the metal film 15 was observed. Further, as a result of evaluating optical characteristics, P-polarized light transmittance was deteriorated by about 1.0% as compared to the case in which no convex structure 14 was formed, but fell within a range that did not affect product performance. The configuration and characteristics are shown in Table 1-1.

### Example 5

PS resin (refractive index: 1.59) was used as the resin substrate 11, and the fine structure 13 was set as a line-and-space structure having a pitch of 150 nm, a line width of 50 nm, and a line height of 100 nm. The convex structures 14 were set to have a width in the line direction of 45 nm, a width in the pitch direction of 45 nm, and a height of 40 nm, and the existence ratio of the convex structures 14 was set to 20%. Further, SiO was used for the adhesion layer 41, and the adhesion layer 41 was formed to have a film thickness of about 10 nm so as to cover the base portion 12, the fine structure 13, and the convex structure 14. Further, aluminum was used for the metal film 15, and a top surface film thickness of the fine structure 13 was set to 70 nm and a side surface film thickness thereof was set to 20 nm. A reflective polarizing element was manufactured in the same manner as in Example 4 for other configurations and a manufacturing method.

When a heat cycle test was performed on the reflective polarizing element in this Example, no peeling of the adhesion layer 41 and the metal film 15 was observed. Further, as a result of evaluating optical characteristics, P-polarized light transmittance was deteriorated by about 8.3% as compared to the case in which no convex structure 14 was formed, but was able to fall within a range usable as product performance. The configuration and characteristics are shown in Table 1-1.

### Example 6

Polyester resin (refractive index: 1.65) was used as the resin substrate 11, and the fine structure 13 was set as a line-and-space structure having a pitch of 130 nm, a line width of 50 nm, and a line height of 100 nm. The convex structures 14 were set to have a width in the line direction of 55 nm, a width in the pitch direction of 50 nm, and a height of 30 nm, and the existence ratio of the convex structures 14 was set to 30%.

Chromium (Cr) was used for the adhesion layer 41, and the adhesion layer 41 was formed to have a film thickness of about 10 nm so as to cover the base portion 12, the fine structure 13, and the convex structure 14. Further, aluminum was used for the metal film 15, and a top surface film thickness of the fine structure 13 was set to 100 nm and a side surface film thickness thereof was set to 40 nm. A reflective polarizing element was manufactured in the same manner as in Example 4 for other configurations and a manufacturing method.

When a heat cycle test was performed on the reflective polarizing element in this Example, no peeling of the adhesion layer 41 and the metal film 15 was observed. Further, as a result of evaluating optical characteristics, P-polarized light transmittance was deteriorated by about 9.4% as compared to the case in which no convex structure 14 was formed, but was able to fall within a range usable as product performance. The configuration and characteristics are shown in Table 1-2.

### Example 7

As illustrated in FIG. 4A and FIG. 4B, an optical element in which the convex structure 14 was provided in the middle of the side surface of the fine structure 13 was manufactured. Polyester resin (refractive index: 1.65) was used as the resin substrate 11, and the fine structure 13 was set as a line-and-space structure having a pitch of 250 nm, a line width of 70 nm, and a line height of 300 nm. The convex structures 14 were set to have a width in the line direction of 30 nm, a width in the pitch direction of 40 nm, and a height of 26 nm, and the existence ratio of the convex structures 14 was set to 5%. Aluminum was used for the metal film 15, and a top surface film thickness of the fine structure 13 was set to 100 nm and a side surface film thickness thereof was set to 40 nm. A reflective polarizing element was manufactured in the same manner as in Example 1 for other configurations and a manufacturing method. However, in the injection molding similar to that of Example 1, the convex structures 14 would be caught by the mold at the time of demolding. For this reason, the molded article was demolded, by decreasing the resin temperature by 5° C. lower than a temperature in normal times at the time of demolding, to subject the molded article to thermal shrinkage. This enabled the amount of deformation of the molded article during demolding to fall within the range of elastic deformation. Thus, the convex structures 14 were formed without damage at the time of demolding.

When a heat cycle test was performed on the reflective polarizing element in this Example, no peeling of the metal film 15 was observed. Further, as a result of evaluating optical characteristics, P-polarized light transmittance was deteriorated by about 1.4% as compared to the case in which no convex structure 14 was formed, but was able to fall within a range usable as product performance. The configuration and characteristics are shown in Table 1-2.

### Comparative Example 1

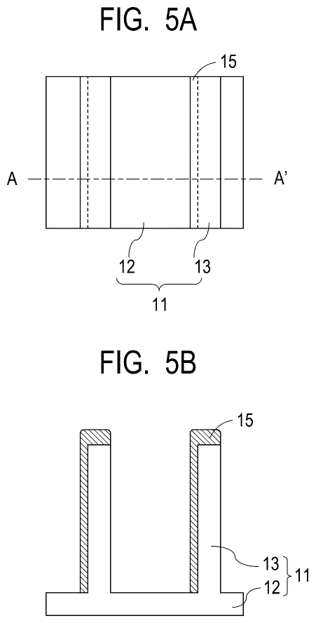

A reflective polarizing element was manufactured in the same manner as in Example 1 except that a convex structure was not provided and COP resin was used as the resin material. The configuration of the reflective polarizing element is illustrated in FIG. 5A and FIG. 5B. FIG. 5A is a schematic plan view, and FIG. 5B is a schematic sectional view of a portion A-A′ in FIG. 5A. The broken line in FIG. 5A indicates the side surface of the fine structure 13 of the resin substrate 11 in a case of the metal film 15 being removed.

In the reflective polarizing element of this Comparative Example, peeling of the metal film 15 occurred from the corner portion formed by the fine structure 13 and the base portion 12, in the heat cycle test. The configuration and characteristics are shown in Table 1-2.

### Comparative Example 2

The fine structure 13 and the convex structures 14 were changed, COP resin was used as the resin material, and the existence ratio was set similar to Example 3. Thus, a reflective polarizing element was manufactured. The existence ratio was 30%, which is the same as in Example 3. Specifically, the fine structure 13 was set as a line-and-space structure having a pitch of 150 nm, a line width of 50 nm, and a line height of 200 nm, and the convex structures 14 were set to have a width in the line direction of 25 nm, a width in the pitch direction of 56 nm, and a height of 60 nm. The configuration and characteristics are shown in Table 1-2.

In the reflective polarizing element of this Comparative Example, the size of the convex structures 14 were large, and hence the P-polarized light transmittance decreased by about 18.8% as compared to Comparative Example 1 in which no convex structure 14 was formed. As a result, the required product performance was not achieved. The configuration and characteristics are shown in Table 1-2.

### Comparative Example 3

A reflective polarizing element was manufactured in the same manner as in Example 1 except that the fine structure 13 and the convex structures 14 were changed and COP resin was used as the resin material. The fine structure 13 was set as a line-and-space structure having a pitch width of 130 nm, a line width of 40 nm, and a line height of 100 nm. The convex structures 14 were set to have a width in the line direction of 50 nm, a width in the pitch direction of 55 nm, and a height of 30 nm, and the existence ratio was set to 40%. The configuration and characteristics are shown in Table 1-2.

In the reflective polarizing element of this Comparative Example, the existence ratio of the convex structures 14 was large, and hence the P-polarized light transmittance decreased by about 12.5% as compared to Comparative Example 1 in which no convex structure 14 was formed. Thus, the required product performance was not achieved. The configuration and characteristics are shown in Table 1-2.

TABLE 1-1

| | | Example 1 | Example 2 | Example 3 | Example 4 | Example 5 |
|---|---|---|---|---|---|---|
| Convex | Line direction | 40 | 30 | 35 | 30 | 45 |
| structure | width [nm] | | | | | |
| | Pitch direction | 30 | 30 | 38 | 25 | 45 |
| | width [nm] | | | | | |
| | Volume [nm³] | 24,000 | 61,200 | 15,960 | 15,000 | 81,000 |
| | Area increase rate | 160 | 239 | 152 | 393 | 456 |
| | [%] | | | | | |
| | Surface area [nm²] | 3,200 | 7,020 | 2,662 | 2,950 | 9,225 |
| | Height [nm] | 20 | 68 | 12 | 20 | 40 |
| | Existence ratio [%] | 1 | 14 | 30 | 5 | 20 |
| Fine | Pitch [nm] | 150 | 150 | 120 | 250 | 150 |
| structure | Width [nm] | 50 | 50 | 40 | 70 | 50 |
| | Height [nm] | 200 | 250 | 100 | 100 | 100 |
| Material | Resin substrate | PES | COP | PC | PMMA | PS |
| | Metal film | Al | Ag | Al | Al | Al |

| | | | | | |
|---|---|---|---|---|---|
| Optical deterioration [%] | 0.21 | 9.92 | 3.75 | 1.04 | 8.33 |
| Film peeling | None | None | None | None | None |

TABLE 1-2

| | | Example | Example | Comparative | Comparative | Comparative |
|---|---|---|---|---|---|---|
| | | 6 | 7 | Example 1 | Example 2 | Example 3 |
| Convex | Line direction | 55 | 30 | No convex | 25 | 50 |
| structure | width [nm] | | | structure | | |
| | Pitch direction | 50 | 40 | | 56 | 55 |
| | width [nm] | | | | | |
| | Volume [nm³] | 82,500 | 31,200 | | 84,000 | 82,500 |
| | Area increase rate | 329 | 674 | | 332 | 178 |
| | [%] | | | | | |
| | Surface area [nm²] | 9,050 | 5,260 | | 9,620 | 7,550 |
| | Height [nm] | 30 | 26 | | 60 | 30 |
| | Existence ratio | 30 | 5 | | 30 | 40 |
| | [%] | | | | | |
| Fine | Pitch [nm] | 130 | 250 | 150 | 150 | 130 |
| structure | Width [nm] | 50 | 70 | 50 | 50 | 40 |
| | Height [nm] | 100 | 300 | 200 | 200 | 100 |
| Material | Resin substrate | PES | PES | COP | COP | COP |
| | Metal film | Al | Al | Al | Al | Al |

| | | | | | |
|---|---|---|---|---|---|
| Optical deterioration [%] | 9.38 | 1.35 | 0 | 18.75 | 12.5 |
| Film peeling | None | None | Present | None | None |

According to the present disclosure, with provision of specific convex structures on a resin substrate, an optical element, which prevents peeling of a metal film or an adhesion layer formed on the resin substrate, and suppresses a decrease in optical performance, can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-220540, filed Dec. 17, 2024, which is hereby incorporated by reference herein in its entirety.

What is claimed is:

1. An optical element comprising:
a resin substrate having:
a base portion, and
a fine structure protruding from the base portion;
a metal film formed on at least a part of a side surface of the fine structure; and
a plurality of convex structures,
wherein each convex structure of the plurality of convex structures is provided on a respective side surface on which the metal film is formed, and
wherein an average value of volumes of the plurality of convex structures is 14,800 nm³ or more and 83,000 nm³ or less.

2. The optical element according to claim 1, wherein the each convex structure of the plurality of convex structures is formed at a respective corner portion formed by the side surface and a surface of the base portion.

3. The optical element according to claim 1, wherein an area of an interface at which the resin substrate contacts the metal film is 160% or more and 680% or less than an area of an interface free of a convex structure.

4. The optical element according to claim 1, wherein an existence ratio of the convex structures, with respect to an evaluation area, as seen from a normal direction of a surface of the base portion on which the fine structure is formed, is 1% or more and 35% or less, and
wherein the existence ratio is a ratio of top surface areas of the plurality of convex structures formed in a region in which the metal film is formed within the evaluation area.

5. An optical element comprising:
a resin substrate having:
a base portion, and
a fine structure protruding from the base portion;
an adhesion layer configured to cover a surface of the resin substrate;
a metal film formed on at least a part of a side surface of the fine structure via the adhesion layer; and
a plurality of convex structures,
wherein each convex structure of the plurality of convex structures is provided on a surface of the base portion, and
wherein an average value of volumes of the plurality of convex structures is 14,800 nm³ or more and 83,000 nm³ or less.

6. The optical element according to claim 5, wherein an existence ratio of the convex structures with respect to an evaluation area, as seen from a normal direction of the surface of the base portion on which the fine structure is formed, is 1% or more and 35% or less, and
wherein the existence ratio is a ratio of top surface areas of the plurality of convex structures within the evaluation area.

7. The optical element according to claim 5, wherein an area of an interface at which the resin substrate contacts the adhesion layer is 160% or more and 680% or less than an area of an interface free of a convex structure.

8. The optical element according to claim 1, wherein the fine structure is a line-and-space structure.

9. The optical element according to claim 8, wherein the metal film is formed on one side surface and a top surface of each line of the fine structure.

10. The optical element according to claim 9, wherein the metal film is an oblique vapor deposition film.

11. The optical element according to claim 1, wherein the fine structure is made of a resin material.

12. The optical element according to claim 1, wherein the base portion is made of a resin material.

13. The optical element according to claim 12, wherein the fine structure and the base portion are formed as an integrally molded body.

14. The optical element according to claim 1, wherein the metal film is made of aluminum.

15. The optical element according to claim 1, wherein a surface area of the each convex structure of the plurality of convex structures is 2,620 nm² or more and 9,230 nm² or less.

16. The optical element according to claim 1, wherein a height of the each convex structure of the plurality of convex structures is 12 nm or more and 68 nm or less.
